(19) United States
(12) Patent Application Publication
(10) Pub. No.: US 2026/0180069 A1
(43) Pub. Date: Jun. 25, 2026

(54) BATTERY PACK EQUIPPED WITH A BUSBAR COOLING STRUCTURE

(71) Applicants: Hyundai Motor Company, Seoul (KR); Kia Corporation, Seoul (KR)

(72) Inventors: June Ho Lee, Hwaseong (KR); Hyun Woo Yoon, Hwaseong (KR); Yoon Hyuk Kang, Hwaseong (KR); Jun Ho Suh, Hwaseong (KR)

(21) Appl. No.: 19/318,463

(22) Filed: Sep. 4, 2025

(30) Foreign Application Priority Data
Dec. 19, 2024 (KR) 10-2024-0191444

(51) Int. Cl. H01M 10/6556; H01M 10/613; H01M 10/625; H01M 50/204; H01M 50/249; H01M 50/291; H01M 50/507

(52) U.S. Cl. CPC H01M 10/6556; H01M 10/613; H01M 10/625; H01M 50/249; H01M 50/291; H01M 50/507; H01M 50/204

(57) ABSTRACT

The present disclosure pertains to a battery pack with cooling structure that obtains an effect of efficient thermal management by cooling a module-connecting busbar and a PRA branch busbar through a second cooling plate. The battery pack may be part of a battery pack system including a vehicle.

### CROSS-REFERENCE TO RELATED APPLICATIONS

The present application claims, under 35 U.S.C. § 119(a), the benefit of Korean Patent Application No. 10-2024-0191444, filed on Dec. 19, 2024, in the Korean Intellectual Property Office, the entire contents of which are incorporated herein by reference.

### BACKGROUND

### (a) Technical Field

The present disclosure relates to a battery pack with a busbar cooling structure.

### (b) Description of the Related Art

Secondary batteries, which have high applicability according to a product group and electrical features such as high energy density, are not only applied to portable devices, but also are generally applied to Electric Vehicles (EVs) or Hybrid Electric Vehicles (HEVs) powered by an electric driving source.

Secondary batteries draw attention as a type of new energy source for improving eco-friendliness and energy efficiency. These secondary batteries have not only a primary advantage of dramatically reducing the use of fossil fuels but also have the advantage of not generating any by-products due to the use of energy.

A battery module may refer to one or more sets of battery cells and may be packaged by as many numbers of battery cells as is needed to satisfy the capacity needed for an EV. A plurality of battery modules may be connected as one by one or more module-connecting busbars, and a battery pack and an inverter may be connected by a power relay assembly (PRA) busbar. As EV performance improves and charging technologies are developed, more heat is generated in busbars.

As shown in FIG. 1, a conventional battery pack uses a method of fixing a busbar by fixing the busbar through a bracket 10 that fixes the busbar from an upper portion of an inner member 11 and bolting the inner member and the bracket through a fixing bolt 12 to fix the busbar. Since, in such a structure, busbars are not in contact with cooling plates, heat generated from the busbars is not able to be cooled and heat, which is generated in a situation in which the battery pack is rapidly charged or discharged, cannot be cooled. A technical solution is thus needed.

The matters described as prior art are only for the purpose of understanding the background of the present disclosure and should not be accepted as recognition of prior art already known to a person with an ordinary skill in the art of the technical field.

### SUMMARY

An objective of the present disclosure is to provide a battery pack including a busbar cooling structure capable of cooling a module-connecting the busbar and a power relay assembly (PRA) branch busbar.

According to at least one embodiment of the present disclosure, there is provided a battery pack. The battery pack may comprise a busbar cooling structure. The battery pack may comprise a first cooling plate, an outer member provided on a upper surface of the first cooling plate and formed to surround the frame and/or a plurality of edges of the first cooling plate, a first inner member, and a second inner member. The first inner member and the second inner member may each be provided on the upper surface of the first cooling plate and formed between portions of the outer member surrounding the frame and/or a plurality of edges of the first cooling plate. The battery pack may comprise a second cooling plate mounted on the upper parts of the outer member and the second inner member, a plurality of module-connecting busbars provided on both sides of the second inner member, and at least one power relay assembly (PRA) branch busbar provided on the upper surface of the second cooling plate.

According to an exemplary embodiment, the second cooling plate may be shaped identically or substantially identically to the first cooling plate.

According to an exemplary embodiment, the second inner member may comprise a base portion formed at a lower portion thereof, a central portion provided at an upper portion of the base portion and formed to have a cross-sectional greater than a cross-sectional width of the base portion, and a support portion provided at an upper portion of the central portion and formed to have a cross sectional width less than a cross-sectional width of the base portion.

According to an exemplary embodiment, the central portion further includes a pair of protrusions formed to protrude upward.

According to an exemplary embodiment, the plurality of module-connecting busbars may be positioned on both sides of the width direction of the support portion.

According to an exemplary embodiment, a cross-sectional width of the central portion may be greater than or equal to a sum of a cross-sectional width of the support portion and cross-sectional widths of the plurality of module-connecting busbars positioned on both sides of the support portion.

According to an exemplary embodiment, the base portion, the central portion, and the support portion may be integrally formed.

According to an exemplary embodiment, the central portion may be formed with a support plate perpendicular to the center of the cross section.

According to an exemplary embodiment, the first cooling plate may comprise a first pad having a first concave portion formed therein, the first concave portion being bent downward to allow the first inner member and the second inner member to be mounted thereon, and a second pad, spaced apart from the first pad by a predetermined distance, comprising a second concave portion formed therein, the second concave portion bent downward at a position corresponding to the first concave portion.

According to an exemplary embodiment, the second cooling plate may comprise a third pad having a third concave portion bent downward to contact the support portion, and a fourth pad, spaced apart from the third pad by a predetermined distance, comprising a fourth concave portion bent downward at a position corresponding to the third concave portion.

According to an exemplary embodiment, the PRA branch busbar may be mounted on the fourth concave portion.

According to an exemplary embodiment, at least a portion of the module-connecting busbar may be in contact with the third concave portion of the third pad.

According to an exemplary embodiment, the PRA branch busbar may be disposed horizontally and is in contact with an upper surface of the second cooling plate, and the module-connecting busbar is disposed vertically and is in contact with a lower surface of the second cooling plate and is disposed vertically on both sides of the second inner member.

According to an exemplary embodiment of the present disclosure, there is provided a vehicle. The vehicle may comprise a vehicle body and a battery pack as described above.

According to an exemplary embodiment of the present disclosure, by cooling the module-connecting busbar and the PR branch busbar through the second cooling plate, the effect of enabling efficient thermal management is achieved.

According to an embodiment of the present disclosure, by cooling the module-connecting busbar and the PR branch busbar, the battery pack and battery pack system are each capable of efficient thermal management, thereby attaining the effect of developing a battery pack using a high-performance battery cell.

In addition, effects obtainable from the present disclosure are not limited to the effects mentioned above, and other effects not mentioned will be clearly understood by a person with an ordinary skill in the art from the following description.

### BRIEF DESCRIPTION OF THE DRAWINGS

The foregoing and other aspects, features, and advantages, as well as the following detailed description of the embodiments, will be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 is a view illustrating a conventional fixed structure of a busbar.

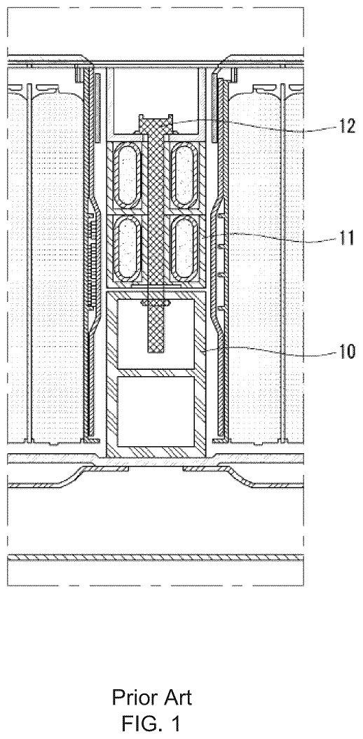

FIG. 2 illustrates a diagram of a battery pack having a busbar cooling structure, according to an exemplary embodiment of the present disclosure.

FIG. 3 illustrates a cross-sectional view taken from line A-A of FIG. 2, according to an exemplary embodiment of the present disclosure.

FIG. 4 illustrates an enlarged view of section (a) of FIG. 3, according to an exemplary embodiment of the present disclosure.

FIG. 5 illustrates example elements of a computing device, according to an exemplary embodiment of the present disclosure.

FIG. 6 illustrates an example architecture of a vehicle, according to an exemplary embodiment of the present disclosure.

### DETAILED DESCRIPTION

Hereinafter, the exemplary embodiment of the present disclosure will be described in detail. This exemplary embodiment is implemented based on the technical solution of the present disclosure, and shows a specific implementation method and a specific operation process, but the protection scope of the present disclosure is not limited to the exemplary embodiment below.

The following Detailed Description is merely provided by way of example and not of limitation. Furthermore, there is no intention to be bound by any expressed or implied theory presented in the preceding background or in the following Detailed Description.

Reference will now be made in detail to various exemplary embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included within the spirit and scope of the various embodiments as defined by the appended claims. Furthermore, in this Detailed Description, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “communicating,” “taking,” “comparing,” “monitoring,” “calibrating,” “estimating,” “initiating,” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as: a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In aspects, a vehicle may comprise an internal combustion engine system as disclosed herein.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example device vibration sensing system and/or electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration. One or more components of an SPU or electronic device described herein may be embodied in the form of one or more of a “chip,” a “package,” an Integrated Circuit (IC).

Terms including ordinals such as “first” and “second”, may be used to describe various elements, but the elements are not limited by the terms. The terms are used only for the purpose of distinguishing one element from another element.

The term “and/or” is used to cover all instances of any combination of the plurality of items for which it is intended. For example, “A and/or B” includes all three cases such as “A”, “B”, and “A and B”.

It will be understood that when an element is referred as being “connected” or “coupled” to another element, it may be directly connected or coupled to the other element, or intervening elements may be present. Meanwhile, when an element is referred to as being “directly connected” or “directly coupled” to another element, it should be understood that there is no intervening element in between.

In the description of embodiments, it will be understood that when a layer (film), area, pattern or structure is referred to as being “on” or “under” another layer (film), area, pad or pattern, it can be directly on the other layer or intervening layers may also be present. The terms “up/on” or “down/under” are based on the appearance shown in the drawings for convenience of description, and are used only to represent the relative positional relationship between the elements for convenience, and should not be understood as limiting the actual positions of the elements. For example, if “on B” is not mentioned or when A or B by feature are not positioned above B, then it is shown only to indicate that B is shown above A in the drawings, and B may be positioned below A, and B and A may be disposed laterally left to right in the actual embodied product.

In addition, the thickness or size of each layer (film), area, pattern or structure in the drawings may be modified for clarity and convenience of description, and thus does not entirely reflect the actual size.

Unless otherwise defined, all terms used herein, including technical or scientific terms, have the same meanings as those generally understood by those skilled in the art to which the present disclosure pertains. It will be further understood that terms, such as those defined in commonly used dictionaries, should be interpreted as having a meaning that is consistent with their meaning in the context of the relevant art and will not be interpreted in an ideal or beyond the formal meaning unless expressly so defined herein.

Hereinafter, embodiments will be described in detail with reference to the accompanying drawings, but the same or corresponding elements are denoted by the same reference numerals regardless of the drawing numbers, and redundant descriptions thereof will be omitted.

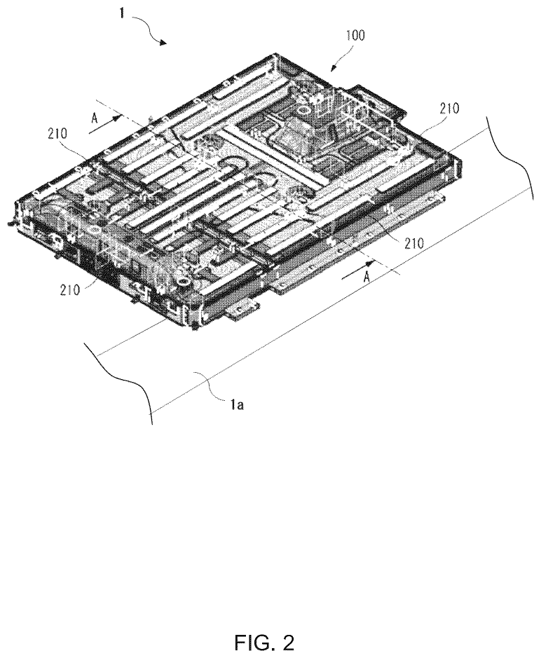

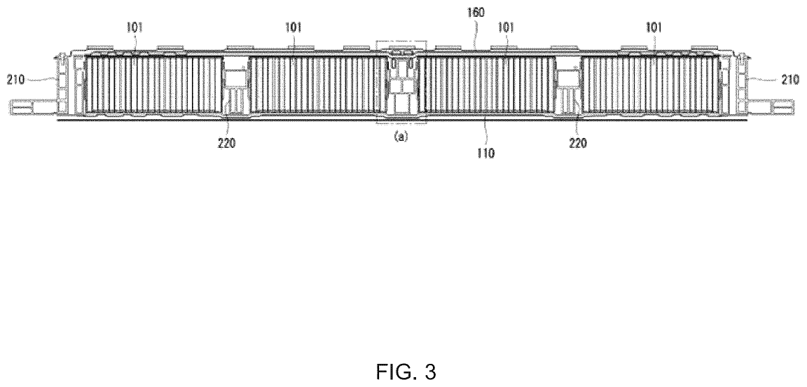

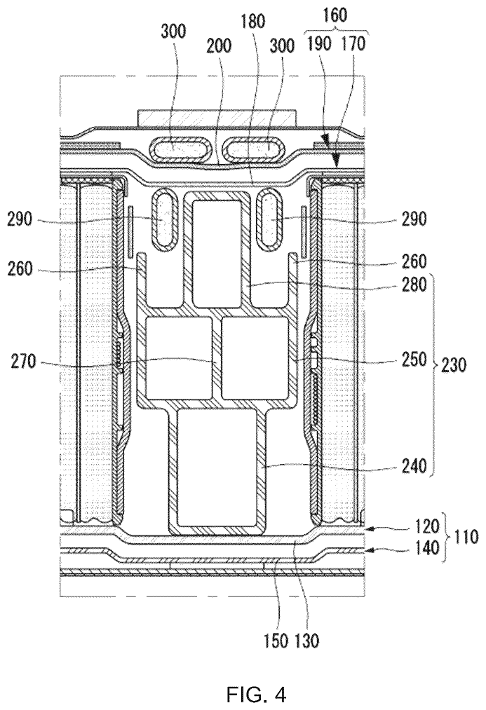

Referring now to FIGS. 2-4, a battery pack 100 including a busbar cooling structure (FIG. 2), a cross-sectional view taken from line A-A of FIG. 2 (FIG. 3), and an enlarged view of section (a) of FIG. 3 (FIG. 4) are illustratively depicted, in accordance with exemplary embodiments of the present disclosure.

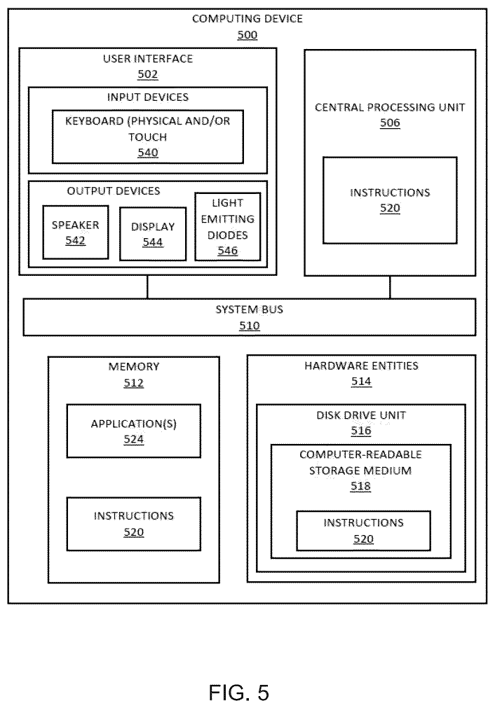

The battery pack 100 may comprise a busbar cooling structure, according to at least one embodiment of the present disclosure. The battery pack may comprise a first cooling plate 110, an outer member 210, a first inner member 220, a second inner member 230, a second cooling plate 160, a module-connecting busbar 290, and a power relay assembly (PRA) branch busbar 300. According to an exemplary embodiment, the battery pack 100 with the busbar cooling structure may comprise a plurality of battery modules 101. According to an exemplary embodiment, in each battery module 101, a plurality of battery cells may be combined into one. According to an exemplary embodiment, the battery pack 100 with the busbar cooling structure may comprise a battery management system (BMS) configured to manage the plurality of battery modules 101. According to an exemplary embodiment, the BMS may be a component of a computing device (e.g., computing device 500, of FIG. 5).

According to an exemplary embodiment, the first cooling plate 110 may be in a rectangular shape, and the plurality of battery modules 101 may be mounted on an upper surface thereof. The first cooling plate 110 may comprise a first pad 120 and a second pad 140. The first pad 120 may comprise a first concave portion 130 that is bent downward so that a first inner member 220 and a second inner member 230 described below are located thereon. The second pad 140 may be spaced apart from the first pad 120 by a predetermined distance, and may comprise a second concave portion 150 which is bent downward at the corresponding position to the first concave portion 130.

The gap between the first pad 120 and the second pad 140 may be formed to a predetermined height so that coolant may sufficiently flow through the interval for cooling the heating battery pack 100.

According to an exemplary embodiment, the first concave portions 130 and the second concave portions 150 may be formed in the same shape. According to an exemplary embodiment, the first concave portion 130 and the second concave portion 150 may be elongated in the longitudinal direction of the first inner member 230 and the second inner member 230.

The first concave portion 130 and the second concave portion 150 may be formed by being bent by a press machine when manufacturing the first pad 120 and the second pad 140. It is noted, however, that other suitable means of manufacture may be incorporated while maintaining the spirit and functionality of the present disclosure.

The outer member 210 may be provided on the upper surface of the first cooling plate 110. According to an exemplary embodiment, the outer member 210 may be formed to surround the edges of the first cooling plate 110. In the outer member 210, a wing portion with a plurality of bolt holes may be formed to protrude outward to fix the battery pack 100 to the vehicle body(1a) of a vehicle(1).

According to an exemplary embodiment, the first inner member 220 may be provided on the upper surface of the first cooling plate 110. The first inner member 220 may be formed between at least two portions of the outer member 210 (e.g. portions surrounding the edges of the first cooling plate 110).

Specifically, in the present embodiment, when four battery modules 101 are disposed along the width direction, the first inner members 220 may be positioned respectively between the first battery module 101 and the second battery module 101 and between the third battery module 101 and the fourth battery module 101.

According to an exemplary embodiment, the second inner member 230 may be provided on the upper surface of the first cooling plate 110. The second inner member 230 may be formed between the outer members 210 (e.g. portions surrounding the edges of the first cooling plate 110).

Specifically, the second inner member 230 may be positioned between the second battery module 101 and the third battery module 101.

The second inner member 230 may comprise a base portion 240, a central portion 250, and a support portion 280. The base portion 240 may be formed at a lower portion of the second inner member 230 and may have a rectangular cross section. The base portion 240 may have a cross-sectional width smaller than a distance between the second battery module 101 and the third battery module 101 so that heat generated from the second battery module 101 and the third battery module 101 may easily discharge.

According to an exemplary embodiment, the central portion 250 may be provided on an upper portion of the base portion 240 and formed to be larger than a cross-sectional width of the base portion 240. According to an exemplary embodiment, the central portion 250 may further comprise a pair of protruding portions 260 protruding upward from both ends of an upper portion of the central portion 250. The central portion 250 may comprise a support plate 270 vertically formed at the center of the cross section thereof.

According to an exemplary embodiment, a cross-sectional width of the central portion 250 may be greater than or equal to a sum of a cross-sectional width of a support portion 280 described below and a cross-sectional width of a plurality of module-connecting busbars 290 positioned on both sides of the support portion 280.

The support portion 280 may be provided on an upper portion of the central portion 250. The support portion 280 may be formed to be smaller than a cross-sectional width of the base portion 240.

According to an exemplary embodiment, the base portion 240, the central portion 250, and the support portion 280 of the first inner member 220 may be integrally formed.

According to an exemplary embodiment, the second cooling plate 160 may be in a rectangular shape, like the first cooling plate 110. The second cooling plate 160 may be mounted on the outer member 210 and the second inner member 230. According to an exemplary embodiment, the second cooling plate 160 may comprise a third pad 170 and a fourth pad 190.

According to an exemplary embodiment, the third pad 170 may comprise a third concave portion 180 that is bent downward to contact the support portion 280.

According to an exemplary embodiment, the fourth pad 190 may be spaced apart from the third pad 170 by a predetermined space. A fourth concave portion 200 bent downward may be formed at the corresponding position to the third concave portion 180.

According to an exemplary embodiment, the third concave portion 180 and the fourth concave portion 200 may be in the same shape. The third concave portion 180 and the fourth concave portion 200 may be elongated in the longitudinal direction of the first inner member 230 and the second inner member 230.

The third concave portion 180 and the fourth concave portion 200 may be formed by being bent by a press machine when manufacturing the third pad 170 and the fourth pad 190.

According to an exemplary embodiment, a plurality of module connection busbars 290 may be provided on both sides of the second inner member 230. A plurality of module-connecting busbars 290 may be positioned on both sides of the support portion 280 in the width direction.

The cross section of the module-connecting busbar 290 may be in a rectangular shape with rounded corners. According to an exemplary embodiment, the module-connecting busbars 290 may be vertically disposed in contact with a lower surface of the second cooling plate 160 and are disposed on both sides of the second inner member 230. Specifically, at least a portion of the module-connecting busbar 290 may be in contact with the third concave portion 180 of the third pad 170.

Accordingly, heat generated from the module-connecting busbar 290 may be cooled by the coolant flowing between the third pad 170 and the fourth pad 190.

At least one power relay assembly (PRA) branch busbar may be provided on an upper surface of the second cooling plate 160. A cross section of the PRA branch busbar 300 may be in a rectangular shape with rounded corners. Specifically, the PRA branch busbar 300 may be mounted on the upper surface of the fourth concave portion 200.

According to an exemplary embodiment, the PRA branch busbar 300 may be disposed horizontally and contacts the upper surface of the second cooling plate 160.

Accordingly, the heat generated from the PRA branch busbar 300 may be cooled by the coolant flowing between the third pad 170 and the fourth pad 190.

Referring now to FIG. 5, an illustration of an example architecture for a computing device 500 is provided. According to an exemplary embodiment, one or more functions of the present disclosure may be implemented by a computing device such as, e.g., computing device 500 or a computing device similar to computing device 500. Computing device 500 may be a quantum computer, a classical computer, and/or have one or more components configured to perform one or more quantum and/or classical computing functions. Computing device 620 may be an example of computing device 500 and/or may comprise one or more components of computing device 500.

The hardware architecture of FIG. 5 represents one example implementation of a representative computing device configured to implement at least a portion of the systems/devices (e.g., battery pack 100 and the BMS) and method(s)/control logic(s) described herein.

Some or all components of the computing device 500 may be implemented as hardware, software, and/or a combination of hardware and software. The hardware may comprise, but is not limited to, one or more electronic circuits. The electronic circuits may comprise, but are not limited to, passive components (e.g., resistors and capacitors) and/or active components (e.g., amplifiers and/or microprocessors). The passive and/or active components may be adapted to, arranged to, and/or programmed to perform one or more of the methodologies, procedures, or functions described herein.

As shown in FIG. 5, the computing device 500 may comprise a user interface 502 (e.g., a graphical user interface), a Central Processing Unit (“CPU”) 506, a system bus 510, a memory 512 connected to and accessible by other portions of computing device 500 through system bus 510, and hardware entities 514 connected to system bus 510. The user interface may comprise input devices and output devices, which may be configured to facilitate user-software interactions for controlling operations of the computing device 500. The input devices may comprise, but are not limited to, a physical and/or touch keyboard 540. The input devices may be connected to the computing device 500 via a wired or wireless connection (e.g., a Bluetooth® connection). The output devices may comprise, but are not limited to, a speaker 542, a display 544, and/or light emitting diodes 546.

At least some of the hardware entities 514 may be configured to perform actions involving access to and use of memory 512, which may be a Random Access Memory (RAM), a disk driver and/or a Compact Disc Read Only Memory (CD-ROM), among other suitable memory types. Hardware entities 514 may comprise a disk drive unit 516 comprising a computer-readable storage medium 518 on which may be stored one or more sets of instructions 520 (e.g., programming instructions such as, but not limited to, software code) configured to implement one or more of the methodologies, procedures, or functions described herein. The instructions 520 may also reside, completely or at least partially, within the memory 512 and/or within the CPU 506 during execution thereof by the computing device 500.

The memory 512 and the CPU 506 may also constitute machine-readable media. The term “machine-readable media”, as used here, refers to a single medium or multiple media (e.g., a centralized or distributed database, and/or associated caches and servers) that store the one or more sets of instructions 520. The term “machine-readable media”, as used here, also refers to any medium that is capable of storing, encoding, or carrying a set of instructions 520 for execution by the computing device 500 and that cause the computing device 500 to perform any one or more of the methodologies of the present disclosure. According to various embodiments, one or more computer applications 524 may be stored on the memory 512.

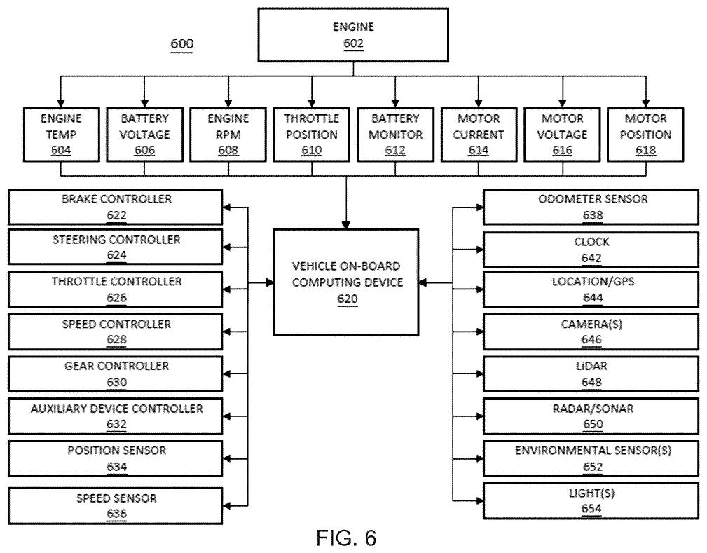

Referring now to FIG. 6, an example vehicle system architecture 600 for a vehicle is provided, in accordance with an exemplary embodiment of the present disclosure. The following discussion of vehicle system architecture 600 is sufficient for understanding one or more components of the vehicle described herein.

As shown in FIG. 6, the vehicle system architecture 600 may comprise an engine, motor or propulsive device 602 and various sensors 604-618 for measuring various parameters of the vehicle system architecture 600, such as, but not limited to, those of the vehicle snapshot described above. In gas-powered or hybrid vehicles having a fuel-powered engine, the sensors 604-618 may comprise, for example, an engine temperature sensor 404, a battery voltage sensor 606, an engine Rotations Per Minute (RPM) sensor 608, and/or a throttle position sensor 610. If the vehicle is an electric or hybrid vehicle, then the vehicle may comprise an electric motor, and accordingly may comprise sensors such as a battery monitoring system 612 (to measure current, voltage and/or temperature of the battery), motor current 614 and voltage 616 sensors, and motor position sensors such as resolvers and encoders 618.

Operational parameter sensors that are common to both types of vehicles may comprise, for example: a position sensor 634 such as an accelerometer, gyroscope and/or inertial measurement unit; a speed sensor 636; and/or an odometer sensor 638. The vehicle system architecture 600 also may comprise a clock 642 that the system uses to determine vehicle time and/or date during operation. The clock 642 may be encoded into the vehicle on-board computing device 620, it may be a separate device, or multiple clocks may be available.

The vehicle system architecture 600 may comprise various sensors that operate to gather information about the environment in which the vehicle is traveling. These sensors may comprise, for example: a location sensor 644 (for example, a Global Positioning System (GPS) device); object detection sensors such as one or more cameras 646; a LiDAR sensor system 648; and/or a radar and/or a sonar system 650. The sensors may comprise environmental sensors 652 such as, e.g., a humidity sensor, a precipitation sensor, a light sensor, and/or ambient temperature sensor. The object detection sensors may be configured to enable the vehicle system architecture 600 to detect objects that are within a given distance range of the vehicle in any direction, while the environmental sensors 652 may be configured to collect data about environmental conditions within the vehicle's area of travel. According to an exemplary embodiment, the vehicle system architecture 600 may comprise one or more lights 654 (e.g., headlights, flood lights, flashlights, etc.).

During operations, information may be communicated from the sensors to an on-board computing device 620. The on-board computing device 620 may be configured to analyze the data captured by the sensors and/or data received from data providers and may be configured to optionally control operations of the vehicle and/or vehicle system based on results of the analysis. For example, the on-board computing device 620 may be configured to control: braking via a brake controller 622; direction via a steering controller 624; speed and acceleration via a throttle controller 626 (in a gas-powered vehicle) or a motor speed controller 628 (such as a current level controller in an electric vehicle); a differential gear controller 630 (in vehicles with transmissions); and/or other controllers. The brake controller 622 may comprise a pedal effort sensor, pedal effort sensor, and/or simulator temperature sensor, as described herein.

Geographic location information may be communicated from the location sensor 644 to the on-board computing device 620, which may then access a map of the environment that corresponds to the location information to determine known fixed features of the environment such as streets, buildings, stop signs and/or stop/go signals. Captured images from the cameras 646 and/or object detection information captured from sensors such as LiDAR 648 may be communicated from those sensors to the on-board computing device 620. The object detection information and/or captured images may be processed by the on-board computing device 620 to detect objects in proximity to the vehicle. Any known or to be known technique for making an object detection based on sensor data and/or captured images may be used in the embodiments disclosed in this document.

What has been described above includes examples of the subject disclosure. It is, of course, not possible to describe every conceivable combination of components or methodologies for purposes of describing the subject matter, but it is to be appreciated that many further combinations and permutations of the subject disclosure are possible. Accordingly, the claimed subject matter is intended to embrace all such alterations, modifications, and variations that fall within the spirit and scope of the appended claims.

In particular and in regard to the various functions performed by the above described components, devices, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter.

The aforementioned systems and components have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components. Any components described herein may also interact with one or more other components not specifically described herein.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Thus, the embodiments and examples set forth herein were presented in order to best explain various selected embodiments of the present invention and its particular application and to thereby enable those skilled in the art to make and use embodiments of the invention. However, those skilled in the art will recognize that the foregoing description and examples have been presented for the purposes of illustration and example only. The description as set forth is not intended to be exhaustive or to limit the embodiments of the invention to the precise form disclosed.

What is claimed is

1. A battery pack, comprising:
a first cooling plate;
an outer member provided on an upper surface of the first cooling plate and formed to surround a plurality of edges of the first cooling plate;
a first inner member and a second inner member,
wherein the first inner member and the second inner member are each provided on the upper surface of the first cooling plate and formed between portions of the outer member surrounding the plurality of edges of the first cooling plate;
a second cooling plate mounted on the outer member and an upper surface of the second inner member;
a plurality of module-connecting busbars provided on both sides of the second inner member; and
at least one power relay assembly (PRA) branch busbar provided on an upper surface of the second cooling plate.

2. The battery pack of claim 1, wherein the second cooling plate is shaped at least substantially identically to the first cooling plate.

3. The battery pack of claim 1, wherein the second inner member comprises:
a base portion formed at a lower portion thereof;
a central portion provided at an upper portion of the base portion and formed to have a cross-sectional width greater than a cross-sectional width of the base portion; and
a support portion provided at an upper portion of the central portion and formed to have a cross-sectional width less than the cross-sectional width of the base portion.

4. The battery pack of claim 3, wherein:
the central portion further comprises a pair of protruding portions protruding upward, and
the plurality of module-connecting busbars are positioned on both sides of a width direction of the support portion.

5. The battery pack of claim 4, wherein the cross-sectional width of the central portion is greater than or equal to a sum of the cross-sectional width of the support portion and cross-sectional widths of the plurality of module-connecting busbars positioned on both sides of the support portion.

6. The battery pack of claim 3, wherein the base portion, the central portion, and the support portion are integrally formed.

7. The battery pack of claim 3, wherein the central portion comprises a support plate vertically formed at a center of a cross-section thereof.

8. The battery pack of claim 1, wherein the first cooling plate comprises:
a first pad comprising a first concave portion which is bent downward to allow the first inner member and the second inner member to be mounted thereon; and
a second pad, spaced apart from the first pad by a predetermined distance, comprising a second concave portion which is bent downward at a position corresponding to the first concave portion.

9. The battery pack of claim 1, wherein the second cooling plate comprises:
a third pad comprising a third concave portion which is bent downward to contact the support portion; and
a fourth pad, spaced apart from the third pad by a predetermined distance, comprising a fourth concave portion which is bent downward at a position corresponding to the third concave portion.

10. The battery pack of claim 9, wherein the PRA branch busbar is mounted on the fourth concave portion.

11. The battery pack of claim 9, wherein at least a portion of the module-connecting busbar is in contact with the third concave portion of the third pad.

12. The battery pack of claim 1, wherein:
the PRA branch busbar is disposed horizontally and is in contact with an upper surface of the second cooling plate, and
the module-connecting busbar is disposed vertically and is in contact with a lower surface of the second cooling plate and is disposed vertically on both sides of the second inner member.

13. A vehicle, comprising:
a vehicle body; and
a battery pack attached to the vehicle body, wherein the battery pack comprises:
a first cooling plate;
an outer member provided on an upper surface of the first cooling plate and formed to surround a plurality of edges of the first cooling plate;
a first inner member and a second inner member,
wherein the first inner member and the second inner member are each provided on the upper surface of the first cooling plate and formed between portions of the outer member surrounding the plurality of edges of the first cooling plate;
a second cooling plate mounted on the outer member and an upper surface of the second inner member;
a plurality of module-connecting busbars provided on both sides of the second inner member; and
at least one power relay assembly (PRA) branch busbar provided on an upper surface of the second cooling plate.

14. The vehicle of claim 13, wherein the second cooling plate is shaped at least substantially identically to the first cooling plate.

15. The vehicle of claim 13, wherein the second inner member comprises:
a base portion formed at a lower portion thereof;
a central portion provided at an upper portion of the base portion and formed to have a cross-sectional width greater than a cross-sectional width of the base portion; and
a support portion provided at an upper portion of the central portion and formed to have a cross-sectional width less than the cross-sectional width of the base portion.

16. The vehicle of claim 15, wherein:
the central portion further comprises a pair of protruding portions protruding upward, and
the plurality of module-connecting busbars are positioned on both sides of a width direction of the support portion.

17. The vehicle of claim 16, wherein the cross-sectional width of the central portion is greater than or equal to a sum of the cross-sectional width of the support portion and cross-sectional widths of the plurality of module-connecting busbars positioned on both sides of the support portion.

18. The vehicle of claim 15, wherein the base portion, the central portion, and the support portion are integrally formed.

19. The vehicle of claim 15, wherein the central portion comprises a support plate vertically formed at a center of a cross-section thereof.

20. The vehicle of claim 13, wherein the first cooling plate comprises:
a first pad comprising a first concave portion which is bent downward to allow the first inner member and the second inner member to be mounted thereon; and
a second pad, spaced apart from the first pad by a predetermined distance, comprising a second concave portion which is bent downward at a position corresponding to the first concave portion.
